(19) United States
(12) Patent Application Publication
(10) Pub. No.: US 2015/0033502 A1
(43) Pub. Date: Feb. 5, 2015

(54) PULLEY MECHANISM

(71) Applicant: IDEAL SANITARY WARE CO., LTD., Foshan (CN)

(72) Inventor: Wuxiang Wei, Foshan (CN)

(73) Assignee: IDEAL SANITARY WARE CO., LTD., Foshan (CN)

(21) Appl. No.: 14/055,262

(22) Filed: Oct. 16, 2013

(30) Foreign Application Priority Data
Jul. 30, 2013 (CN) 201320457981.3

(51) Int. Cl. E05D 15/06

(52) U.S. Cl. CPC E05D 15/06
USPC 16/91

(57) ABSTRACT

A pulley mechanism is disclosed comprising a roller seat, a hanging supporter fixed to a door structure and connected to the roller seat with a first fastener, and at least one roller fixed to the roller seat to allow the roller seat to move slidably. The pulley mechanism further comprises an elastic element, and the roller seat comprises a first seat for supporting one end of the elastic element, whereas the hanging supporter comprises a second seat for supporting another end of the elastic element. The relative position of the roller seat and the hanging supporter can be adjusted by the first fastener and the elastic element disposed between the first seat and the second seat.

### CROSS-REFERENCE TO RELATED APPLICATIONS

The present application claims priority from Chinese utility model application No. 201320457981.3 filed on Jul. 30, 2013, the disclosure of which is hereby incorporated herein by reference.

### FIELD OF THE INVENTION

The present invention relates to a pulley mechanism and in particular, to a pulley mechanism used in door assembly for adjusting the relative position of the frames thereof.

### BACKGROUND OF THE INVENTION

Conventionally, a pulley mechanism of a sliding door comprises a roller seat and a hanging supporter connected with each other by a pin through pinholes thereof. However, when the pinhole of the roller seat is not concentric with that of the hanging supporter, it is difficult to mount the hanging supporter to the roller seat by a pin. In this case, when assembling the sliding door, the user must adjust the relative position of the roller seat and the hanging supporter so that their pinholes are concentric with each other. It is time consuming to assemble the sliding door in this way. In addition, it is noisy when the pulley mechanism is moved along the frame rail of the sliding door, because no damping element is provided in the pulley mechanism.

### BRIEF SUMMARY OF THE INVENTION

An object of the present invention is to provide a pulley mechanism which generates smaller noise when moving along the frame rail and can be assembled easily by adjusting the relative position of the roller seat and the hanging supporter with an elastic element and a fastener.

To achieve the objective above, a pulley mechanism is provided which comprises a roller seat, a hanging supporter fixed to a door structure and connected to the roller seat with a first fastener, and at least one roller fixed to the roller seat to allow the roller seat to move slidably. The pulley mechanism further comprises an elastic element. The roller seat comprises a first seat for supporting one end of the elastic element, whereas the hanging supporter comprises a second seat for supporting another end of the elastic element. The relative position of the roller seat and the hanging supporter can be adjusted by the first fastener and the elastic element disposed between the first seat and the second seat.

In the present invention, the relative position of the roller seat and the hanging supporter can be adjusted by the elastic element and/or the first fastener individually or in combination. Additionally, the noise generated during the movement of the roller along the rail, is minimized due to the damping effect of the elastic element disposed between the roller seat and the hanging supporter.

In one embodiment of the present invention, the roller seat comprises a flange, whereas the hanging supporter comprises a groove matching with the flange, allowing the hanging supporter to be guided during its movement relative to the roller seat.

In one preferred embodiment, the elastic element is a compression spring.

In another preferred embodiment, the roller seat further comprises a guiding element disposed within the compression spring, one end of the guiding element being fixed to the first seat or the second seat, which can prevent the compression spring from clinging during compressing it.

In one embodiment of the present invention, there are two or more elastic elements arranged symmetrical with the first fastener.

In one embodiment of the present invention, the hanging supporter includes a boss and the pulley mechanism further includes a limitation structure, wherein the boss matches with the limitation structure after going through a hole formed on the door structure, so as to connect the hanging supporter to the door structure.

In one preferred embodiment, the boss has an internal threaded hole and the limitation structure is a baffle plate so that the hanging supporter is connected to the door structure by a second fastener matching with the internal threaded hole and the baffle plate.

In one embodiment the present invention, the roller seat has a sliding groove cooperative with a frame of the door structure, to avoid the roller to run off the rail during movement.

In another embodiment, mechanism further comprises an adjustable stop mechanism disposed on the roller seat. The stop mechanism can contact with a damping device mounted on the door structure in a predefined position to cushion the collision generated in the predefined position by the stop mechanism and the damping device.

In one embodiment, the roller seat has an axle on which the roller is mounted and around which the roller is rotatable.

### BRIEF DESCRIPTION OF THE DRAWINGS

FIG. 1 shows a detached view of an exemplary pulley mechanism according to one embodiment of the invention;

FIG. 2 shows another detached view of the pulley mechanism shown in FIG. 1;

FIG. 3 shows a perspective view of the pulley mechanism shown in FIG. 1 during assembling;

FIG. 4 shows another perspective view of the pulley mechanism shown in FIG. 1 after being assembled.

### DETAILED DESCRIPTION

The present invention will now be described in more detail with reference to the drawings. It should be noted that the terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” include any and all combinations of one or more of the associated listed items. It will be further understood that the terms “comprises” “comprising” “includes” and/or “including” when used herein, specify the presence of stated features, integers, steps, operations, elements, and/or components, but do not preclude the presence or addition of one or more other features, integers, steps, operations, elements, components, and/or groups thereof.

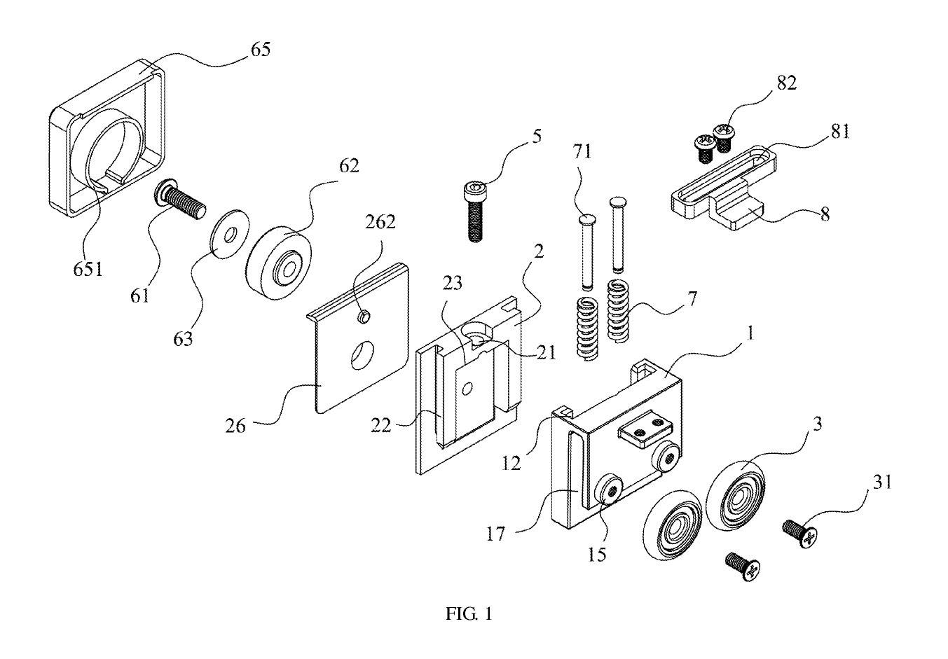

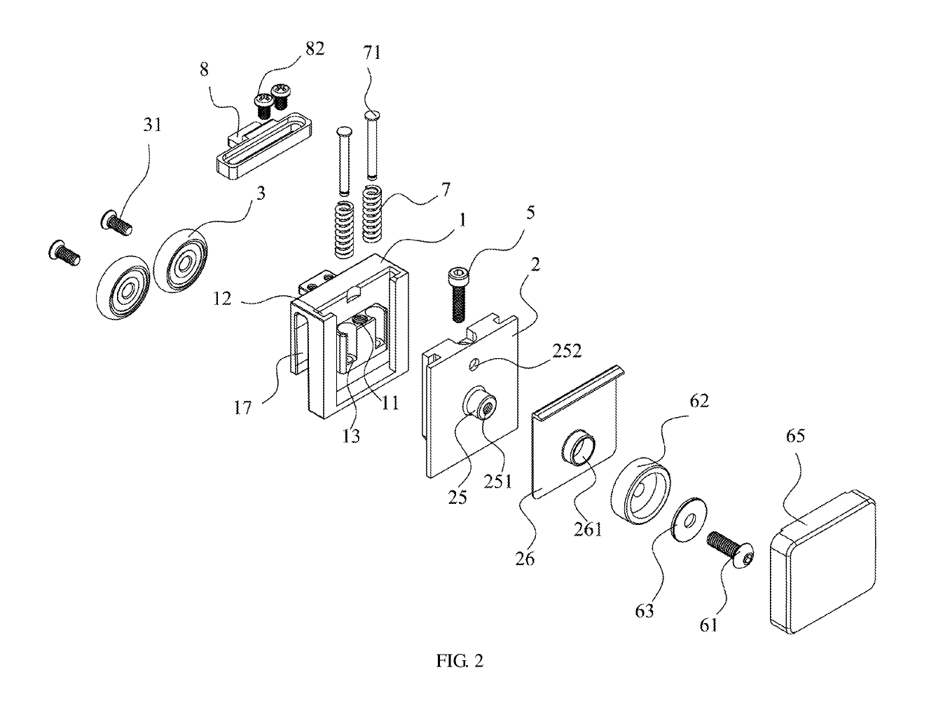

FIGS. 1 and 2 show a pulley mechanism according to one embodiment of the present invention. The pulley mechanism comprises a roller seat 1, a hanging supporter 2, and at least one roller 3, wherein the roller 3 is mounted to the roller seat 1 so as to allow the roller seat 1 to move slidably along a rail (not shown) which generally is a top frame of the door assembly. The hanging supporter 2 is connected to the roller seat 1 by a first fastener 5, such as a screw. The pulley mechanism further includes an elastic element 7. The relative position of the roller seat 1 and the hanging supporter 2 can be adjusted by the elastic element 7 and the first fastener 5. In the present invention, it is believed that the elastic element 7 is helpful to adjust the relative position of the roller seat 1 and the hanging supporter 2, and the noise generated during the movement of the pulley mechanism along the rail can be reduced by the aid of the damping effect of the elastic element 7.

In one embodiment of the present invention, in the roller seat 1 is formed an internal threaded hole 11 matching with the first fastener 5, and a through hole 21 is formed in the hanging supporter 2. The roller seat 1 and the hanging supporter 2 are connected with each other detachably by the first fastener 5 being matching with the internal threaded hole 11. In another embodiment of the present invention, the internal threaded hole can be formed in the hanging supporter 2, and the through hole can be formed in the roller seat 1.

In one embodiment of the present invention, the roller seat 1 has a flange 12, and the hanging supporter 2 has a groove 22 correspondingly which can cooperate with the flange 12. The flange 12 can slide in the groove 22 to guide the movement of the hanging supporter 2 relative to the roller seat 2 in a direction parallel to the groove 22. In another embodiment of the present invention, the flange can also be formed in the hanging supporter 2, whereas the groove can also be formed in the roller seat 1. In an alternative embodiment, the roller seat 1 and the hanging supporter 2 can also have both flange and groove.

In one embodiment of the present invention, the roller seat 1 has a first seat 13 for supporting one end of the elastic element 7, whereas the hanging supporter 2 has a second seat 23 for supporting another end of the elastic element 7, allowing the elastic element 7 to be disposed between the first seat 13 and the second seat 23 after the pulley mechanism is assembled.

In one preferred embodiment, the elastic element 7 can be a compression spring. Further, the first seat 13 and/or the second seat 23 are blind holes with a length smaller than that of the compression spring 7. In the embodiment shown in FIGS. 1 and 2, the compression spring 7 is disposed vertically so that the upper end of the compression spring 7 is supported on the first seat 13, and the lower end is supported on the second seat 23.

In one more preferred embodiment, two or more elastic elements 7 are arranged symmetrical with the first fastener 5 to prevent the roller seat 1 or the hanging supporter 2 from inclining during adjusting the relative position of the roller seat 1 and the hanging supporter 2. In the embodiment shown in the FIGS. 1 and 2, there are two elastic elements 7 arranged symmetrical with the first fastener 5.

During assembling, the flange 12 is inserted into the groove 22 when the elastic element 7 is mounted between the first seat 13 and the second seat 23, and then the first fastener 5 is screwed into the internal threaded hole 11 after going through the through hole 21. The elastic element 7 is compressed by screwing the first fastener 5 so as to achieve the relative movement of the roller seat 1 and the hanging supporter 2 until the hanging supporter 2 is fixed in a desired position.

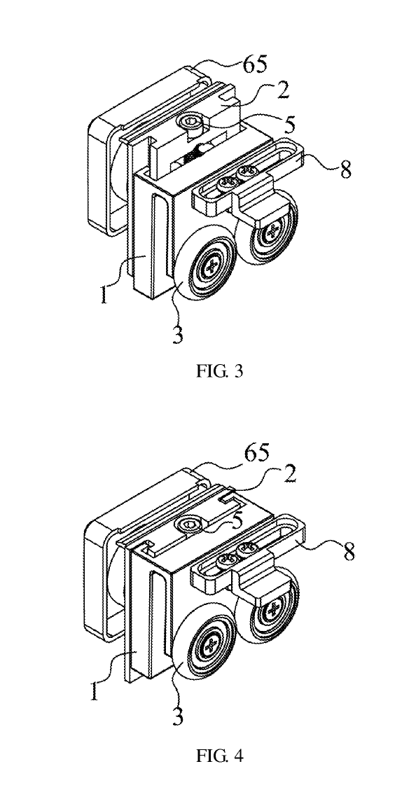

The relative position of the roller seat 1 and the hanging supporter 2 can be adjusted in opposite directions by screwing the first fastener 5. For example, when the elastic element 7 is compressed by screwing the first fastener 5 in clockwise direction, the hanging supporter 2 is moved downwardly relative to the roller seat 1, as shown in the FIG. 4. When the elastic element 7 is released by screwing the first fastener 5 in anticlockwise direction, the hanging supporter 7 is moved upwardly relative to the roller seat 1, as shown in the FIG. 3.

In another preferred embodiment, a guiding element 71, such as a pin, is disposed within the compression spring. One end of the guiding element 71 is fixed to the first seat 13 or the second seat 23. The guiding element 71 can prevent the compression spring 7 from bending during compressing or releasing the compression spring 7.

In one embodiment of the present invention, the hanging supporter 2 includes a boss 25 which can go through a hole formed in the door structure. Meanwhile, the pulley mechanism further includes a limitation structure 26 matching with the boss 25. The boss 25 goes through the hole of the door structure and cooperates with the limitation structure 26 to connect the door structure to the hanging supporter 2.

In one preferred embodiment, the limitation structure 26 may be for example, a baffle plate in which a through hole 261 is formed. Correspondingly, the boss 25 has an internal threaded hole 251. A second fastener 61, for example a screw, can go through the through hole 261 and cooperate with the internal threaded hole 251 to mount the door structure on the boss 25 between the hanging supporter 2 and the baffle plate 26.

In another embodiment, a pressing ring 62 and a gasket 63 are arranged between the baffle plate 26 and the second fastener 61. The second fastener 61 can go through the gasket 63, the pressing ring 62 and the through hole 261, and then be screwed into the internal threaded hole 251. In addition, a cap 65 having a circular elastic ring 651 is connected to the pressing ring 62 by the circular elastic ring 651 clamping the cylindrical surface of the pressing ring 62.

The baffle plate further includes a positioning projection 262, and the hanging supporter 2 has correspondingly a positioning hole 252. The positioning projection 262 can be inserted into the positioning hole 252 so as to prevent the hanging supporter 2 from rotating about the boss 25 during the assembling.

In one embodiment of the present invention, the roller seat 1 can include an axle 15 on which the roller 3 is mounted rotatably by a screw 31. In the embodiment shown in FIG. 1, there are two rollers 3. However, in other embodiments, there can be three or more rollers.

In one embodiment of the present invention, the roller seat 1 can includes a sliding groove 17 in which a portion of the frame of the door structure can be arranged to avoid the rollers 3 to run off the rail during its movement.

In one embodiment of the present invention, the pulley mechanism further includes an adjustable stop mechanism 8 having an adjusting groove 81. The stop mechanism 8 can be fixed to the roller seat 1 by a screw 82 through the adjusting groove 81. During sliding the door structure, the stop mechanism 8 can contact with a damping device (not shown) mounted on the door structure in a predefined position to cushion the collision generated in the predefined position by the stop mechanism and the damping device.

It should be understood that various example embodiments have been described with reference to the accompanying drawings in which only some example embodiments are shown. The present invention, however, may be embodied in many alternate forms and should not be construed as limited to only the example embodiments set forth herein.

1. A pulley mechanism comprising a roller seat, a hanging supporter fixed to a door structure and connected to the roller seat with a first fastener, and at least one roller fixed to the roller seat to allow the roller seat to move slidably, wherein,
the pulley mechanism further comprises an elastic element, and
the roller seat comprises a first seat for supporting one end of the elastic element, whereas the hanging supporter comprises a second seat for supporting another end of the elastic element,
wherein the relative position of the roller seat and the hanging supporter can be adjusted by the first fastener and the elastic element disposed between the first seat and the second seat.

2. The pulley mechanism of claim 1, wherein the roller seat comprises a flange, whereas the hanging supporter comprises a groove matching with the first flange, allowing the hanging supporter to be guided during its movement relative to the roller seat.

3. The pulley mechanism of claim 1, wherein the elastic element is a compression spring.

4. The pulley mechanism of claim 3, wherein the roller seat further comprises a guiding element disposed within the compression spring, one end of the guiding element being fixed to the first seat or the second seat.

5. The pulley mechanism of claim 1, wherein there are two or more elastic elements arranged symmetrical with the first fastener.

6. The pulley mechanism of claim 1, wherein the hanging supporter includes a boss and the pulley mechanism further includes a limitation structure, wherein the boss matches with the limitation structure after going through a hole formed on the door structure, to connect the hanging supporter to the door structure.

7. The pulley mechanism of claim 6, wherein the boss has an internal threaded hole and the limitation structure is a baffle plate so that the hanging supporter is connected to the door structure by a second fastener matching with the internal threaded hole and the baffle plate.

8. The pulley mechanism of claim 1, wherein the roller seat has a sliding groove cooperative with a frame of the door structure.

9. The pulley mechanism of claim 1, wherein the pulley mechanism further comprises an adjustable stop mechanism disposed on the roller seat.

10. The pulley mechanism of claim 1, wherein the roller seat has an axle on which the roller is mounted and around which the roller is rotatable.
